(19) United States
(12) Patent Application Publication
(10) Pub. No.: US 2005/0284285 A1
(43) Pub. Date: Dec. 29, 2005

(54) Musical device having jingles and adapted for cooperative use with percussion instrument

(76) Inventors: Ted McCann, Los Angeles, CA (US); Jimmy Paxson, Los Angeles, CA (US); John Ferrante, West Hollywood, CA (US)

Correspondence Address: THOMAS B. LUEBBERING;HOVEY WILLIAMS LLP, Suite 400, 2405 Grand, Kansas City, MO, 64108, US

(21) Appl. No.: 10/878,743

(22) Filed: Jun. 28, 2004

(51) Int. Cl. G10D 13/02

(52) U.S. Cl. 84/418

(57) ABSTRACT

A musical device (10) adapted for cooperative use with a drum (11) or similar percussion instrument such that striking or otherwise sounding the percussion instrument also sounds the musical device (10). In a preferred embodiment, the musical device (10) comprises a ring (12) and a plurality of jingles (14). The ring (12) being adapted to support the jingles (14) and to removably lay upon a drumhead (15) portion of the drum (11). The plurality of jingles (14) are coupled with the ring (12) and are movable so as to affect a desired sound in response to a striking of the drum (11). No jingles (14) are coupled with a reserved portion (22) of the ring (12) so as to facilitate substantially unimpeded access to the drumhead (15) via the reserved portion (22).

### BACKGROUND OF THE INVENTION

1. Field of the Invention

The present invention relates broadly to tambourines or other musical instruments or devices having a plurality of small disks, bells, or other jingles. More particularly, the present invention relates to a musical device having jingles and adapted for removable and cooperative use with a drum or similar percussion instrument such that striking or otherwise sounding the percussion instrument also sounds the jingles of the musical device.

2. Description of the Prior Art

It is often desirable to accompany the sounding of a drum or other percussion instrument with the shimmering sound of a plurality of moving disks, bells, or other jingles. This desire is perhaps most evident in the design of the common tambourine. The tambourine is generally a drum, or tambour, comprising a shallow cylindraceous body, a drumhead stretched across at least one open end of the body, and a plurality of jingles integrated into or otherwise substantially permanently affixed to the body such that striking the drumhead or shaking the tambourine causes the jingles to sound. The importance of the tambourine as a musical instrument is evidenced, for example, in its use by Mozart and other classical composers and by its presence in western percussion sections where it is sometimes used to suggest or impart an exotic or eastern flavor, as in, for example, Tchaikovsky's Arabian Dance from The Nutcracker Suite. Tambourines are also used by relatively recent and current artists in such popular genres as rock and roll, pop, rhythm and blues, adult contemporary, etc.

There are, however, musical genres and instances wherein it may be desirable to inject the shimmering sound of jingles without actually using a tambourine. Unfortunately, few options exist, and musicians are often forced to purchase or rent, transport, play, and maintain the tambourine in order to have use of its associated jingles. Often, the tambourine is merely shaken to sound the jingles and the drumhead is ignored, possibly even being removed altogether, in favor of larger drums.

It is also known in the prior art to mount the tambourine on a stand so as to incorporate it into a standard drum kit. Unfortunately, the drummer may not be able to strike a more desired drum while simultaneously striking the tambourine to sound the jingles. Thus, the added responsibility and inconvenience of the tambourine can interfere with the drummer's timing or ability to play more complex pieces.

Due to the above-identified and other problems and disadvantages in the prior art, a need exists for an improved mechanism for associating jingles with drums.

### SUMMARY OF THE INVENTION

The present invention overcomes the above-described and other problems and disadvantages in the prior art by providing a musical device adapted for removable and cooperative use with a drum or similar percussion instrument such that striking or otherwise sounding the percussion instrument also sounds the musical device. In a preferred embodiment, the musical device comprises a ring and a plurality of jingles. The ring is adapted to support the jingles and to removably lay upon the drum. The ring is lightweight and otherwise constructed in such a manner so as not to interfere with playing the drum or with the quality of sound produced by the drum.

The plurality of jingles are coupled with and supported by the ring and are movable so as to affect the desired sound in response to a striking of the drum. The jingles are spaced apart and movably coupled with the ring, though no jingles are present on a reserved portion of the ring to allow for substantially unrestricted access to the drumhead by the drummer. In a preferred embodiment of the jingles, each jingle includes a rivet; an upper disk; and a lower disk. The rivet is adapted to retain the upper and lower disks in physical association with the ring while allowing for an amount or degree of movement necessary to produce the desired sound. The upper and lower disks cooperate by striking one another to produce the desired sound of the jingle.

In exemplary use and operation, a ring of appropriate dimensions and desired sound quality is placed upon a drumhead such that the associated jingles project upwardly. The ring or the rivets may rest directly upon the drumhead. The reserved portion of the ring which is free of jingles is oriented toward the drummer to allow for substantially unrestricted access to the drumhead and unimpeded use of the drummer's stick or hand in striking the drumhead. Thereafter, striking the drumhead elicits vibratory or other movement that is transferred to the jingles, thereby causing them to sound.

Thus, it will be appreciated that the musical device of the present invention provides a number of substantial advantages over the tambourines of the prior art, including, for example, allowing for removably associating jingles with an existing drum or similar percussion instrument such that striking or otherwise sounding the percussion instrument also sounds the jingles. In a conventional tambourine the jingles are integrated into the tambourine's shallow cylindraceous body, making them permanently part of an independent and distinct musical instrument, i.e., the tambourine. This connectedness or integration with the tambourine can be a disadvantage where only the jingles are desired but the entire tambourine must be owned, transported, played, and maintained in order to have the jingles. Furthermore, in order to sound the jingles the tambourine must be played; making it difficult for a drummer to sound the jingles in conjunction with one or more other drums. The present invention advantageously separates the jingles from the tambourine to provide a musical device that can be easily and removably associated with any drum desirable. This is accomplished by associating the jingles with the lightweight ring that is laid upon any size drumhead, rather than permanently integrating them into the cylindraceous body of the drum as is done in the prior art.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a top view of a preferred embodiment of the musical device of the present invention; and

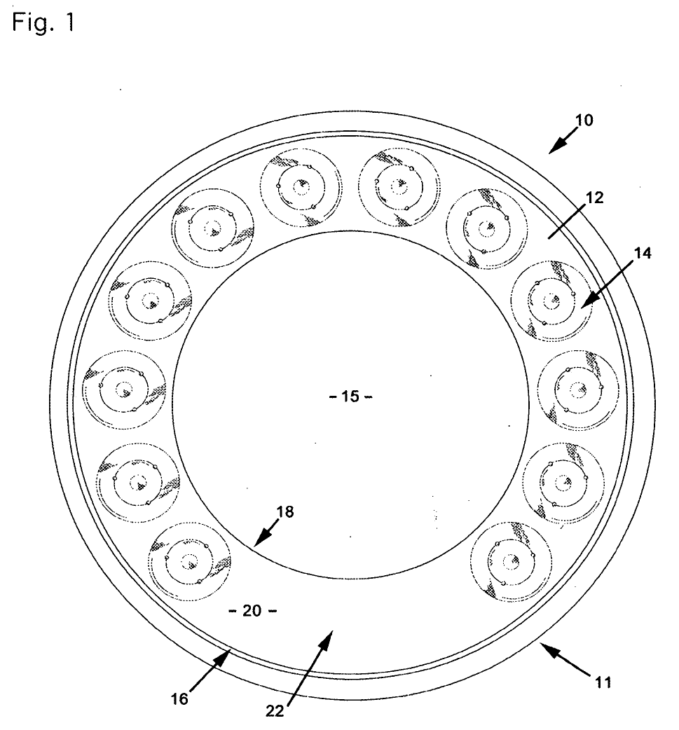

FIG. 2 is a fragmentary elevation view of the musical device shown in FIG. 1 and emphasizing a jingle component.

### DETAILED DESCRIPTION OF A PREFERRED EMBODIMENT

With reference to the figures, a musical device 10 is herein described, shown, and otherwise disclosed in accordance with a preferred embodiment of the present invention. Broadly, the musical device 10 is adapted for removable and cooperative use with a drum 11 or similar percussion instrument such that striking or otherwise sounding the percussion instrument also sounds the musical device 10.

In the illustrated preferred embodiment, the musical device 10 comprises a ring 12 and a plurality of jingles 14. The ring 12 is adapted to support the jingles 14 and to removably lay upon, couple with, or otherwise associate with the drum 11 or a drumhead 15 portion thereof. The ring 12 is substantially flat or planar and lightweight and presents both an outer diameter 16 and an inner diameter 18, with the outer diameter 16 being greater than the inner diameter 18. The size of the ring 12, particularly the outer diameter 16, will depend on the size of the drumhead 15 (e.g., 10, 12, 13, 14, 16, 18, 20, 21, or 22 inches) with which the musical device 10 is to be used. For example, in one contemplated implementation for a particular type and size of drum, the outer diameter of the ring is approximately fourteen inches. The ring 12 should be lightweight and otherwise constructed in such a manner so as not to interfere with playing the drum 11 or with the quality of sound produced by the drum 11. Thus, the ring 12 may be constructed of plastic, nylon, fiberglass, wood, or another similarly suitable material.

The plurality of jingles 14 are coupled with and supported by the ring 12 and are movable so as to affect the desired sound potential. The jingles 14 may be disks, bells, or other objects constructed of any suitable material including, for example, metal, wood, or shell. The size and number of the jingles 14 may depend on such factors as, for example, the desired level of sound and the size of the drum 11. For example, in the aforementioned contemplated implementation having an outer ring diameter of 14 inches, there may be 12 jingles, each 1.5 inches in diameter. The jingles 14 are spaced apart and movably coupled with the ring 12 in a space 20 between and defined by the outer and inner ring radii 16,18. No jingles are present on a reserved portion 22 of the ring 12 to allow for substantially unrestricted access to the drumhead 15 so that the drummer can strike the drumhead 15 without interference.

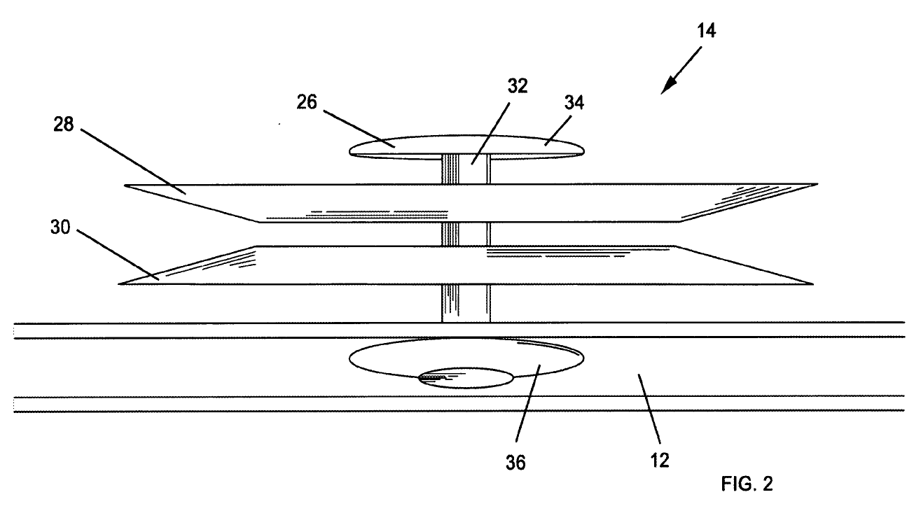

In a preferred embodiment of the jingles 14, referring particularly to FIG. 2, each jingle 14 includes a rivet 26 or other suitable fastener; an upper disk 28; and a lower disk 30. The rivet 26 is adapted to retain the upper and lower disks 28,30 in physical association with the ring 12 while allowing for an amount of movement necessary to produce the desired sound. The rivet 26 includes a columnar body 32; an upper stop 34; and a lower stop 36. The columnar 32 body passes through a hole in the ring 12 so as to project substantially perpendicularly through the plane of the ring 12. The upper and lower stops 34,36 are affixed to opposite ends of the columnar body 32 to maintain the columnar body 32 in physical association with the ring 12 by preventing its removal through the hole. It will be appreciated that, as desired, the rivet 26 may be replaced or augmented by another suitable fastener.

The upper and lower disks 28,30 cooperate by striking one another to produce the desired sound of the jingle 14. The upper and lower disks 28,30 are substantially flat but may be provided with a beveled peripheral surface to enhance sound quality, and present a center hole through which the columnar body 32 of the rivet 26 passes. The thicknesses of the upper and lower disks 28,30 and the length of the columnar body 32 are such as to allow for sufficient movability of the upper and lower disks 28,30 relative to one another in order to produce the desired sound. The ring 12 and the upper stop 34 of the rivet 32 maintain the upper and lower disks 28,30 in physical association with the ring 12.

In exemplary use and operation, the musical device 10 of the present invention functions as follows. The ring 12, being of an appropriate dimension, is placed upon a drumhead 15 such that the associated jingles 14 project upwardly. The ring 12 or the lower stops 36 of the rivets 26 may rest directly upon the drumhead 15. The reserved portion 22 of the ring 12 which is free of jingles 14 is oriented toward the drummer to allow for substantially unrestricted access to the drumhead 15 and unimpeded use of the drummer's stick or hand in striking the drumhead 15. Thereafter, striking the drumhead 15 elicits vibratory or other movement that is transferred to the jingles 14, thereby causing them to sound. When finished playing, the musical device 10 can be conveniently disassociated from the drum 11 by simply lifting the ring 12 from the drumhead 15, thereby facilitating maintenance, replacement, other use, and transportation. The musical device 10 can also be attached to the side of a bass drum with hook-and-loop material or another suitable removable or quick-release attachment mechanism.

From the preceding description it will be appreciated that the musical device of the present invention provides a number of substantial advantages over the tambourines of the prior art, including, for example, allowing for removably associating jingles with an existing drum or similar percussion instrument such that striking or otherwise sounding the percussion instrument also sounds the jingles. In a conventional tambourine the jingles are permanently integrated into the wall of the tambourine's shallow cylindraceous body, making them permanently part of an independent and distinct musical instrument, i.e., the tambourine. This connection with the tambourine can be a disadvantage where only the jingles are desired but the entire tambourine must be owned, transported, played, and maintained in order to have the jingles. Furthermore, in order to sound the jingles the tambourine must be played; making it difficult for a drummer to sound the jingles in conjunction with one or more other drums. The present advantage advantageously separates the jingles from the tambourine to provide a musical device that can be easily and removably associated with any drum desirable. This is accomplished by associating the jingles with the lightweight ring that is laid upon the drumhead, rather than permanently integrating them into the cylindraceous body of the drum as is done in the prior art.

Although the invention has been described with reference to the preferred embodiments illustrated in the drawings, it is noted that equivalents may be employed and substitutions made herein without departing from the scope of the invention as recited in the claims. In particular, as mentioned, the jingles are not limited to metal disks and may instead be of any desired type, such as, for example, bells or pieces of shell.

1. A musical device comprising:
a ring; and
a plurality of jingles coupled with the ring,
wherein the ring is removably associatable with a drumhead such that striking the drumhead causes the plurality of jingles to sound.

2. The musical device as set forth in claim 1, wherein the ring is substantially planar.

3. The musical device as set forth in claim 1, wherein the ring is constructed of a lightweight material.

4. The musical device as set forth in claim 1, wherein all of the jingles are arranged about and coupled with a first portion of the ring, and none of the jingles are arranged about or coupled with a reserved portion of the ring, thereby allowing for substantially unimpeded access to the drumhead via the reserved portion of the ring.

5. The musical device as set forth in claim 1, wherein each of the jingles includes—
a rivet including—
a body adapted to fit through a corresponding hole in the ring, and
an upper stop and a lower stop associated with opposite ends of the columnar body so as to prevent complete removal of the columnar body through the hole in the ring; and
an upper disk and a lower disk movably coupled with the columnar body and maintained thereupon by the ring and the upper stop,
wherein movement of the upper disk and lower disk upon the columnar body and against one another sounds the jingle.

6. A musical device comprising:
a substantially planar ring constructed of a lightweight material and adapted for removable association with a drumhead; and
a plurality of jingles coupled with the ring, wherein all of the jingles are arranged about and coupled with a first portion of the ring, and none of the jingles are arranged about or coupled with a reserved portion of the ring, thereby allowing for substantially unimpeded access to the drumhead via the reserved portion of the ring,
wherein striking the drumhead causes the plurality of jingles to sound.

7. The musical device as set forth in claim 6, wherein each of the jingles includes—
a rivet including—
a body adapted to fit through a corresponding hole in the ring, and
an upper stop and a lower stop associated with opposite ends of the columnar body so as to prevent complete removal of the columnar body through the hole in the ring; and
an upper disk and a lower disk movably coupled with the columnar body and maintained thereupon by the ring and the upper stop,
wherein movement of the upper disk and lower disk upon the columnar body and against one another sounds the jingle.

8. A musical device comprising:
a substantially planar ring constructed of a lightweight material and adapted for removable association with a drumhead; and
a plurality of jingles coupled with the ring, wherein each of the jingles includes—
a rivet including—
a body adapted to fit through a corresponding hole in the ring, and
an upper stop and a lower stop associated with opposite ends of the columnar body so as to prevent complete removal of the columnar body through the hole in the ring, and
an upper disk and a lower disk movably coupled with the columnar body and maintained thereupon by the ring and the upper stop,
wherein all of the jingles are arranged about and coupled with a first portion of the ring, and none of the jingles are arranged about or coupled with a reserved portion of the ring, thereby allowing for substantially unimpeded access to the drumhead via the reserved portion of the ring, and wherein striking the drumhead causes movement of the upper disks and lower disks upon the columnar bodies and against one another, thereby sounding the jingles.

9. A musical apparatus comprising:
a drum having a drumhead;
a substantially planar ring constructed of a lightweight material and adapted for removable association with the drumhead; and
a plurality of jingles coupled with the ring, wherein each of the jingles includes—
a rivet including—
a body adapted to fit through a corresponding hole in the ring, and
an upper stop and a lower stop associated with opposite ends of the columnar body so as to prevent complete removal of the columnar body through the hole in the ring, and
an upper disk and a lower disk movably coupled with the columnar body and maintained thereupon by the ring and the upper stop,
wherein all of the jingles are arranged about and coupled with a first portion of the ring, and none of the jingles are arranged about or coupled with a reserved portion of the ring, thereby allowing for substantially unimpeded access to the drumhead via the reserved portion of the ring, and wherein striking the drumhead causes movement of the upper disks and lower disks upon the columnar bodies and against one another, thereby sounding the jingles.
